(19) United States
(12) Patent Application Publication
(10) Pub. No.: US 2009/0083451 A1
(43) Pub. Date: Mar. 26, 2009

(54) METHOD AND SYSTEM FOR CREATING A COMPUTER PERIPHERAL INTERFACE PORT THAT DETECTS WIRELESS PROTOCOL-SWITCHABLE DEVICES AND ENABLES SEAMLESS SWITCHING TO A WIRELESS CONNECTION UPON SAFE REMOVAL FROM THE COMPUTER PERIPHERAL INTERFACE PORT

(76) Inventor: SUSANN M. KEOHANE, AUSTIN, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/861,592

(22) Filed: Sep. 26, 2007

(51) Int. Cl. G06F 13/10

(52) U.S. Cl. 710/11

(57) ABSTRACT

Disclosed are a method, system and computer program product for detecting wireless protocol-switchable devices connected to a computer peripheral interface port and enabling seamless switching to a wireless connection upon safe removal from the computer peripheral interface (PI) port. A Wireless Protocol Switching (WPS) utility detects a request for safe removal of one or more connected peripherals. The WPS utility detects whether one or more connected peripherals support a wireless connectivity. Upon detecting whether one or more connected peripherals supports a wireless connectivity, a request for a peripheral selection is prompted. After receipt of a peripheral selection for switching the one or more connected peripherals supporting a wireless connectivity, the WPS utility prompts the connected peripheral supporting wireless connectivity to switch to the wireless protocol. The one or more connected peripherals supporting wireless connectivity are then switched to the wireless protocol.

### BACKGROUND OF THE INVENTION

1. Technical Field

The present invention relates in general to the field of computers and similar technologies. More particularly, the invention relates to a method and system for detecting wireless protocol switchable devices connected to a computer peripheral interface port and enabling seamless switching to a wireless connection upon safe removal from the computer interface port.

2. Description of the Related Art

Existing computer system designers have been gradually replacing “legacy” serial and parallel communications ports with “modern” communications ports. Generally, a legacy port is a port or connector on a computer system that is considered fully or partially obsolete. In the case of personal computer systems, legacy serial ports (or “serial ports”) usually refer to serial ports that are compatible with Recommended Standard (RS)-232, which was originally intended to interface with a modem or similar communication device. Because of deprecated operating system (OS) support for the RS-232 compatible serial port, RS-232 ports have been gradually superseded in personal computers by modem serial ports. These modem serial ports include Universal Serial Bus (USB) version 2.0 ports and IEEE 1394 high-speed serial bus ports. Modem serial ports allow peripherals to be connected using a single standardized interface socket, which improves plug-and-play capabilities by allowing devices to be connected and disconnected without rebooting the computer (via a process known as “hot swapping”).

However, many computer systems suffer from the disadvantage that they have too few USB ports to accommodate the number of peripherals (i.e. devices that are connected to the computer system externally). For instance, most laptop computers are equipped with only two USB ports. With more peripherals requiring modem serial ports (e.g. USB ports, IEEE 1394 ports) over legacy serial ports, the computer user is burdened with having to prioritize and decide which connected peripheral to remove from the modem port in order to connect another peripheral to the system.

To alleviate this problem, a growing number of USB-enabled peripherals are designed to connect to a computer system by switching a connection mechanism to a wireless communication standard, such as the Bluetooth® (trademark of the Bluetooth Special Interest Group) or Certified Wireless USB™ (trademark of Universal Serial Bus Implementers Forum (USB-IF). As dual USB/Bluetooth-enabled peripherals become more available, what is needed is a computer system that detects which USB-connected peripherals car, be switched to wireless communications protocols, such as Bluetooth®.

### SUMMARY OF THE INVENTION

Disclosed are a method, system and computer program product for detecting wireless protocol-switchable devices connected to a computer peripheral interface port and enabling seamless switching to a wireless connection upon safe removal from the computer peripheral interface (PI) port. A Wireless Protocol Switching (WPS) utility detects a request for safe removal of one or more connected peripherals. The connected peripheral(s) include a USB-enabled peripheral, a peripheral interface (PI)-enabled peripheral, a dual USB/wireless-enabled peripheral, and a dual PI/wireless-connected peripheral. The WPS utility detects whether one or more connected peripherals support a wireless connectivity. Upon detecting whether one or more connected peripherals supports wireless connectivity, a request for a peripheral selection is prompted. After receipt of a peripheral selection for switching the one or more connected peripherals supporting a wireless connectivity, the WPS utility prompts the connected peripheral supporting wireless connectivity to switch to the wireless protocol. The one or more connected peripherals supporting wireless connectivity are then switched to the wireless protocol.

The above, as well as additional purposes, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, where:

FIG. 1 is a high level block diagram representation of an exemplary data processing system (DPS), according to one embodiment of the invention;

FIG. 2 is a high level block diagram representation of an exemplary peripheral communications interface architecture, in accordance with one embodiment of the invention; and

FIG. 3 represents a high-level logical flowchart illustrating the method of detecting wireless protocol-switchable devices connected to a computer peripheral interface port, in accordance with one embodiment of the invention.

### DETAILED DESCRIPTION OF AN ILLUSTRATIVE EMBODIMENT

The illustrative embodiments provide a method, system and computer-usable medium for detecting wireless protocol-switchable peripherals connected to a computer peripheral interface port and enabling seamless switching to a wireless connection when the peripheral is safely removed from the computer interface port, in accordance with one embodiment of the invention.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that term is utilized.

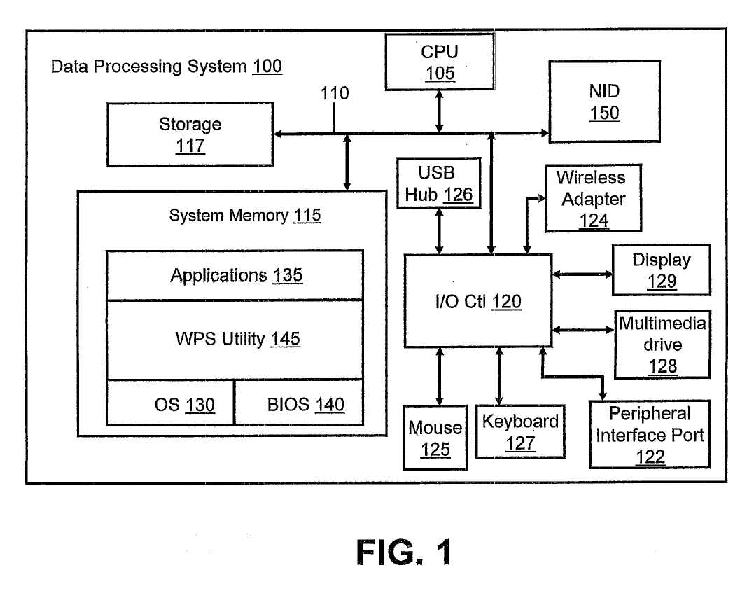

With reference now to FIG. 1, depicted is a block diagram representation of an exemplary data processing system (DPS) 100 within which the features of the invention are implemented. DPS 100 comprises at least one processor or central processing unit (CPU) 105 connected to system memory 115 via system interconnect/bus 110. Also connected to system bus 110 is I/O controller 120, which provides connectivity and control for input devices, of which pointing device (or mouse) 125 and keyboard 127 are illustrated, and output devices, of which display 129 is illustrated. Additionally, multimedia drive 128 (e.g., CDRW or DVDRW drive) and Universal Serial Bus (USB) hub 126 are illustrated, coupled to I/O controller 120. Moreover, Wireless Adapter 124 is connected to I/O controller 120. In alternate embodiments, Wireless Adapter 124 may be externally connected via USB hub 126, PC Card (CardBus) slot (not shown), and/or memory card slot (not shown). Wireless Adapter 124 is a device that provides wireless connectivity between DPS 100, and secondary devices equipped with wireless capability. There are various types of wireless adapters 124, including but not limited to Wi-Fi™ (a trademark of Wi-Fi Alliance), cellular, and Bluetooth®. Multimedia drive 128 and USB hub 126 may operate as both input and output (storage) mechanisms. DPS 100 also comprises storage 117, within which data/instructions/code may be stored. DPS 100 is also illustrated with a network interface device (NID) 150 coupled to system bus 110. NID 150 enables DPS 100 to connect to one or more access networks, such as the Internet.

Notably, in addition to the above described hardware components of DPS 100, various features of the invention are completed via software (or firmware) code or logic stored within system memory 115 or other storage (e.g., storage 117) and executed by CPU 105. In one embodiment, data/instructions/code from storage 117 populates the system memory 115, which is also coupled to system bus 110. System memory 115 is defined as a lowest level of volatile memory (not shown), including, but not limited to, cache memory, registers, and buffers. Thus, illustrated within system memory 115 are a number of software/firmware components, including operating system (OS) 130 (e.g., Microsoft Windows®, a trademark of Microsoft Corp; or GNU®/Linux®, registered trademarks of the Free Software Foundation and The Linux Mark Institute; or Advanced Interactive eXecutive—AIX—®, registered trademark of International Business Machines—IBM), applications (APP) 135, Basic Input/Output System (BIOS) 140 and Wireless Protocol Switching (WPS) utility 145. BIOS 140 contains the basic routines for the transfer information between elements within DPS 100 and recognize and configure device drivers for hardware devices, such as USB hub 126, during boot-up of DPS 100. In actual implementation, components or code of OS 130 and BIOS 140 may be combined with those of WPS utility 145, collectively providing the various functional features of the invention when the corresponding code is executed by the CPU 105. For simplicity, WPS utility 145 is illustrated and described as a stand alone or separate software/firmware component, which is stored in system memory 115 to provide/support the specific novel functions described herein.

CPU 105 executes WPS utility 145 as well as OS 130, which supports the user interface features of WPS utility 145. In the illustrative embodiment, WPS utility 145 facilitates the detection of wireless protocol-switchable devices connected to a computer peripheral interface port. Among the software code/instructions provided by WPS utility 145, and which are specific to the invention, are code/instructions for: (a) detecting a request for safe removal of at least one connected peripheral; (b) detecting whether the connected peripheral supports a wireless connectivity via a wireless protocol; (c) prompting a request for a peripheral selection; (d) receiving a peripheral selection for switching the connected peripheral supporting a wireless connectivity to the wireless protocol; (e) prompting the connected peripheral supporting the wireless connectivity to switch to the wireless protocol; and (f) switching the connected peripheral supporting the wireless connectivity to the wireless protocol.

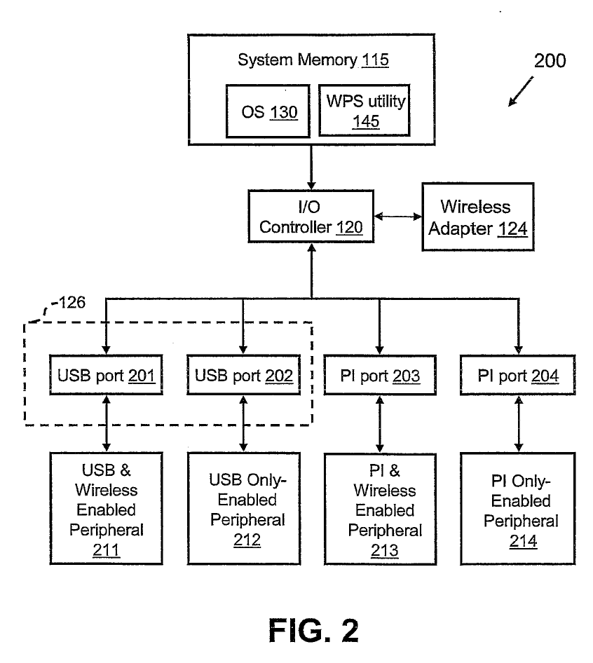

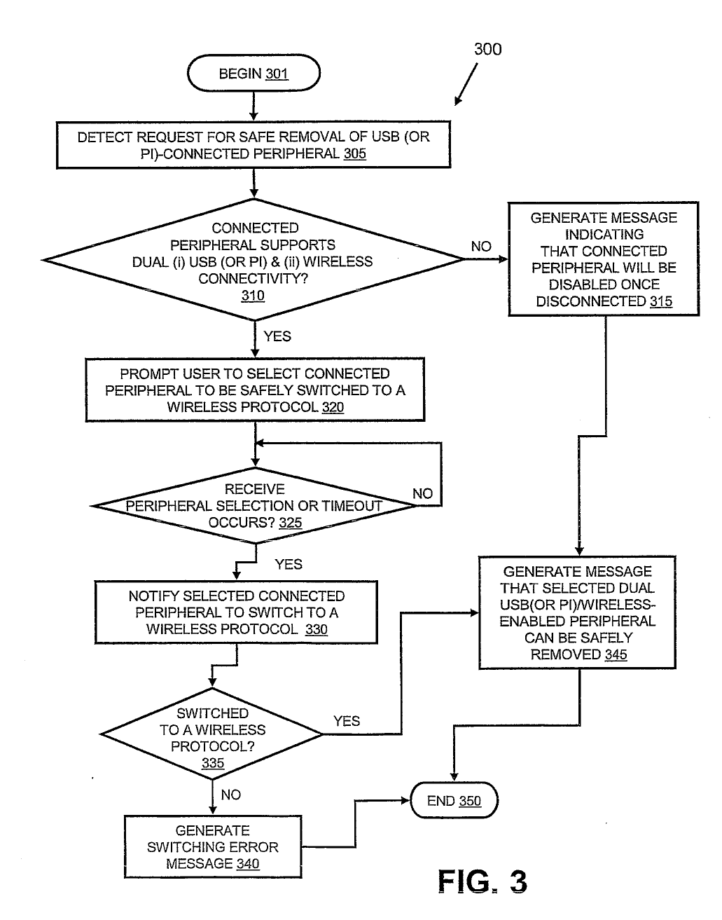

For simplicity of the description, the collective body of code that enables these various features is referred to herein as WPS utility 145. According to the illustrative embodiment, when CPU 105 executes WPS utility 145, DPS 100 initiates a series of functional processes that enable the above functional features as well as additional features/functionality, which are described below within the description of FIGS. 2-3.

Those of ordinary skill in the art will appreciate that the hardware and basic configuration depicted in FIG. 1 may vary. For example, other devices/components may be used in addition to or in place of the hardware depicted. The depicted example is not meant to imply architectural limitations with respect to the present invention. The data processing system depicted in FIG. 1 may be, for example, an IBM eServer pSeries system, a product of International Business Machines Corporation in Armonk, N.Y., running the AIX operating system or LINUX operating system. Moreover, the functionality of WPS utility 145 is not limited to USB-to-Wireless switching, and vice versa. Rather other implementations may generally cover any peripheral interface port-to-wireless switching mechanism where the connected peripheral supports a dual connectivity (i.e. connectivity via peripheral interface port 122 and connectivity via wireless adapter 124).

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIGS. 1 and 2xx for FIG. 2). The specific numerals assigned to the elements are provided solely to aid in the description and not meant to imply any limitations (structural or functional) on the invention.

With reference now to FIG. 2, an exemplary peripheral communications interface architecture (PCIA) 200 is shown, according to one embodiment of the invention. PCIA 200 includes I/O controller 120 (FIG. 1), which serves as a control interface between system memory 115 (FIG. 1), USB hub 126, and peripheral interface (PI) ports 203 and 204. USB hub 126 includes two USB ports 201-202, which in turn are used to connect USB-enabled peripherals 211 and 212. According to this exemplary embodiment, USB port 201 and PI port 203 are connected to dual USB/wireless-enabled peripheral 211 and dual PI/wireless-enabled peripheral 213, respectively. Moreover, USB port 202 and PI port 204 are connected to USB only-enabled peripheral 212 and PI only-enabled peripheral 214, respectively. I/O controller 120 also interfaces with wireless adapter 124, which is used to connect to wireless-enabled peripherals via Bluetooth® or similar wireless communications standard. OS 130 (FIG. 1) and WPS utility 145 (FIG. 1) interface with I/O controller 120 to control the various steps in detecting wireless protocol-switchable devices (i.e., 211 and 213) that are connected to computer peripheral interface ports (i.e., USB port 201 and PI port 203, respectively).

FIG. 3 represents a flow chart illustrating the exemplary method of detecting wireless protocol-switchable devices connected to a computer peripheral interface port, according to an illustrative embodiment of the invention. Although the following method illustrated in FIG. 3 may be described with reference to components shown in FIGS. 1-2, it should be understood that this exemplary method is merely for convenience and alternative components and/or configurations thereof can be employed when implementing the method. Key portions of the method may be completed by WPS utility 145 (FIG. 1) and OS 130 (FIG. 1). WPS utility 145 executes within DPS 100 (FIG. 1). Moreover, WPS utility 145 and OS 130 control specific operations of/on DPS 100 (FIG. 1) and PCIA 200 (FIG. 2). Thus, the method is described from the perspective of WPS utility 145, DPS 100, and/or PCIA 200.

The process 300 of FIG. 3 begins at initiator block 301 and proceeds to block 305, in which WPS utility 145 detects a request for the safe removal of one or more USB-connected peripherals 211-212 (or PI-connected peripherals 213-214). As used herein, the term “safe removal” refers to the ability to disconnect a peripheral from a USB or PI port during system operation (or “hot removal”), such that neither the computer, the peripheral nor the user can be harmed by removing the peripheral. A determination is then made whether one or more of the USB-connected peripherals that are requested for safe removal supports dual USB/wireless connectivity, as depicted in block 310. If any of the requested peripherals does not support dual USB/wireless connectivity (or dual PI/wireless connectivity), WPS utility 145 generates a message indicating that the communications between the USB-connected peripheral (or PI-connected peripheral) and the respective USB port (or PI port) will be disabled once the USB-connected peripheral (or PI-connected peripheral) is disconnected, as depicted in block 315. From block 315, the method continues to block 345 (described below). Thus, according to the exemplary embodiment shown in FIG. 2, the user would be informed that USB only-enabled peripheral 212 and PI only-enabled peripheral 214 would be automatically disabled upon the physical disconnection of peripherals 212, 214 from USB port 202 and PI port 204, respectively.

However, if one or more of the USB-connected (or PI-connected) peripherals supports: (i) dual USB/wireless connectivity (e.g. USB/wireless enabled peripheral 211), and/or (ii) dual PI/wireless connectivity (e.g. PI/wireless enabled peripheral 213), the method continues to block 320, in which WPS utility 145 prompts the user to make a peripheral selection. The peripheral selection is selection of one or more USB-connected (or PI-connected) peripherals to switch to a wireless protocol. At decision block 325, a determination is made by WPS utility 145 whether (i) WPS utility 145 has received a selection of one or more dual USB (or PI)/wireless-enabled peripherals (i.e., 211 and/or 213) for safe removal or (ii) a timeout occurs. The method 300 waits at step 325 until conditions (i) and/or (ii) of step 325 occur, and then proceeds to block 330. At block 330, OS 130 notifies the selected dual USB/wireless-enabled peripheral (i.e., 211 and/or 213) to switch from a current USB (or PI) protocol to a wireless protocol, as depicted in block 330. A determination is then made whether one or more of the selected dual USB (or PI)/wireless-enabled peripherals (i.e., 211 and/or 213) have been successfully switched to a wireless protocol, as depicted in block 335. The determination is typically made via detection by wireless adapter 124 (FIGS. 1 and 2). If any of the selected dual USB (or PI)/wireless-enabled peripherals have not been successfully switched to a wireless protocol, WPS utility 145 generates a switching error message, as depicted in block 340, and the method proceeds to termination block 350. However, if the selected dual USB (or PI)/wireless-enabled peripheral has been successfully switched to a wireless protocol, WPS utility 145 generates a signal/message indicating that the selected dual USB (or PI)/wireless-enabled peripheral can be safely removed from respective USB port 201 and/or PI port 203, as depicted in block 345. The wireless-enabled peripheral then continues to communicate with DPS 100 via wireless adapter 124. The method terminates at block 350.

As a result, this method allows a user to replace the previous USB-connected peripheral with a non-wireless (i.e., USB-only) enabled peripheral. The USB-only device would take the place of the dual USB/Bluetooth-enabled peripheral that was previously connected to the USB port.

In the flow chart above (FIG. 3), the method is embodied in a computer readable medium containing computer readable code such that a series of steps are performed when the computer readable code is executed on a computing device. In some implementations, certain steps of the method are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As will be further appreciated, the processes in embodiments of the present invention may be implemented using any combination of software, firmware, or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. By way of example, a non-exclusive list of types of media includes recordable-type (tangible) media such as floppy disks, thumb drives, hard disk drives, CD ROMs, DVD ROMs, and transmission-type media such as digital and analog communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. In a computing device, a method for detecting wireless protocol-switchable devices connected to a computer peripheral interface port, the method comprising:
detecting a request for safe removal of at least one connected peripheral from a group including a USB-enabled peripheral, a peripheral interface (PI)-enabled peripheral, a dual USB/wireless-enabled peripheral, and a dual PI/wireless-connected peripheral;
detecting whether at least one connected peripheral supports a wireless connectivity via a wireless protocol;
prompting a request for a peripheral selection;
receiving a peripheral selection for switching the at least one connected peripheral supporting a wireless connectivity to the wireless protocol;
prompting the at least one connected peripheral supporting the wireless connectivity to switch to the wireless protocol; and
switching the at least one connected peripheral supporting the wireless connectivity to the wireless protocol.

2. The method of claim 1, further comprising:
detecting whether the at least one connected peripheral supporting the wireless connectivity is switched to the wireless protocol;
wherein a switching error message is generated if the at least one connected peripheral supporting the wireless connectivity is not switched to the wireless protocol.

3. A computer system comprising:
a processor unit;
a memory coupled to the processor unit;
one or more of a USB port and a peripheral interface (PI) port;
a wireless adapter; and
a Wireless Protocol Switching (WPS) utility executing on the processor unit and having executable code for:
detecting a request for safe removal of at least one connected peripheral from a group including a USB-enabled peripheral, a peripheral interface (PI)-enabled peripheral, a dual USB/wireless-enabled peripheral, and a dual PI/wireless-connected peripheral;
detecting whether at least one connected peripheral supports a wireless connectivity via a wireless protocol;
prompting a request for a peripheral selection;
receiving a peripheral selection for switching the at least one connected peripheral supporting a wireless connectivity to the wireless protocol;
prompting the at least one connected peripheral supporting the wireless connectivity to switch to the wireless protocol; and
switching the at least one connected peripheral supporting the wireless connectivity to the wireless protocol.

4. The computer system of claim 3, the WPS utility further having executable code for:
detecting whether the at least one connected peripheral supporting the wireless connectivity is switched to the wireless protocol;
wherein a switching error message is generated if the at least one connected peripheral supporting the wireless connectivity is not switched to the wireless protocol.

5. A computer program product comprising:
a computer storage medium; and
program code on the computer storage medium that when executed provides the functions of:
detecting a request for safe removal of at least one connected peripheral from a group including a USB-enabled peripheral, a peripheral interface (PI)-enabled peripheral, a dual USB/wireless-enabled peripheral, and a dual PI/wireless-connected peripheral;
detecting whether at least one connected peripheral supports a wireless connectivity via a wireless protocol;
prompting a request for a peripheral selection;
receiving a peripheral selection for switching the at least one connected peripheral supporting a wireless connectivity to the wireless protocol;
prompting the at least one connected peripheral supporting the wireless connectivity to switch to the wireless protocol; and
switching the at least one connected peripheral supporting the wireless connectivity to the wireless protocol.

6. The computer program product of claim 5, the program code further provides the functions of:
detecting whether the at least one connected peripheral supporting the wireless connectivity is switched to the wireless protocol;
wherein a switching error message is generated if the at least one connected peripheral supporting the wireless connectivity is not switched to the wireless protocol.
